(19) United States
(12) Patent Application Publication
(10) Pub. No.: US 2023/0081243 A1
(43) Pub. Date: Mar. 16, 2023

(54) ROTOR SLEEVE WITH DUAL MAGNETIC PHASE ARRANGEMENT

(71) Applicant: DANFOSS A/S, Nordborg (DK)

(72) Inventors: Tianlei LI, Tallahassee, FL (US); Delvis Anibal GONZALEZ, Tallahassee, FL (US)

(21) Appl. No.: 17/792,166

(22) PCT Filed: Jun. 30, 2020
(86) PCT No.: PCT/US2020/040225

§ 371 Date: Jul. 12, 2022

Related U.S. Application Data
(60) Provisional application No. 62/987,414, filed on Mar. 10, 2020.

(51) Int. Cl. H02K 1/28; F25B 31/02

(52) U.S. Cl. CPC H02K 1/28; F25B 31/026

(57) ABSTRACT

An electric machine according to an exemplary aspect of the present disclosure includes, among other things, an electric machine including a rotor having a sleeve radially outside a permanent magnet. Further, the sleeve includes at least one magnetic arc segment and at least one non-magnetic arc segment.

### RELATED APPLICATIONS

This application claims the benefit of U.S. Provisional Application No. 62/987,414, filed Mar. 10, 2020, the entirety of which is herein incorporated by reference.

### TECHNICAL FIELD

This disclosure relates to an electric machine, such as a motor for a refrigerant compressor or a generator in a power plant, including a rotor sleeve with a dual magnetic phase arrangement.

### BACKGROUND

Refrigerant compressors are used to circulate refrigerant in a chiller via a refrigerant loop. Refrigerant loops are known to include a condenser, an expansion device, and an evaporator. The compressor compresses the refrigerant, which then travels to a condenser, which in turn cools and condenses the refrigerant. The refrigerant then goes to an expansion device, which decreases the pressure of the fluid, and to the evaporator, where the refrigerant is vaporized, completing a refrigeration cycle.

Many refrigerant compressors are centrifugal compressors and have an electric motor that drives at least one impeller to pressurize refrigerant. The at least one impeller is mounted to a rotatable shaft. The motor in some examples is an electric motor including a rotor and a stator.

### SUMMARY

An electric machine according to an exemplary aspect of the present disclosure includes, among other things, an electric machine including a rotor having a sleeve radially outside a permanent magnet. Further, the sleeve includes at least one magnetic arc segment and at least one non-magnetic arc segment.

In a further embodiment, the sleeve is configured to rotate with the permanent magnet.

In a further embodiment, a stator radially surrounds the sleeve, and the stator is arranged such that an air gap is present radially between the stator and the sleeve.

In a further embodiment, the sleeve includes at least one pair of magnetic arc segments and at least one pair of non-magnetic arc segments alternately arranged about a circumference of the sleeve.

In a further embodiment, the magnetic and non-magnetic arc segments are not mechanically independent such that the sleeve does not include any circumferential seams.

In a further embodiment, the sleeve includes a plurality of rings axially abutted to one another.

In a further embodiment, each of the rings is arranged such that the magnetic and non-magnetic arc segments are aligned both radially and circumferentially with the magnetic and non-magnetic arc segments, respectively, of an adjacent ring.

In a further embodiment, the magnetic and non-magnetic arc segments extend along an entire length of the sleeve.

In a further embodiment, the sleeve includes a non-magnetic outer casing.

In a further embodiment, the permanent magnet is connected to a shaft via the sleeve.

In a further embodiment, the sleeve is radially flush with the shaft.

In a further embodiment, the sleeve projects radially outward of the shaft.

In a further embodiment, the electric machine is configured for use in a refrigerant compressor used in a heating, ventilation, and air conditioning (HVAC) chiller system.

In a further embodiment, the electric machine is one of a motor and a generator.

A refrigerant compressor for a heating, ventilation, and air conditioning (HVAC) chiller system according to an exemplary aspect of this disclosure includes, among other things, an impeller, a shaft connected to the impeller, and an electric motor including a rotor having a sleeve radially outside of a permanent magnet. The sleeve connects the rotor to the shaft, and the sleeve includes at least one magnetic arc segment and at least one non-magnetic arc segment.

In a further embodiment, the sleeve includes at least one pair of magnetic arc segments and at least one pair of non-magnetic arc segments alternately arranged about a circumference of the sleeve.

In a further embodiment, the magnetic and non-magnetic arc segments are not mechanically independent such that the sleeve does not include any circumferential seams.

In a further embodiment, the sleeve includes a plurality of rings axially abutted to one another, and each of the rings is arranged such that the magnetic and non-magnetic arc segments are aligned both radially and circumferentially with the magnetic and non-magnetic arc segments, respectively, of an adjacent ring.

### BRIEF DESCRIPTION OF THE DRAWINGS

FIG. 1 schematically illustrates an example refrigerant system.

FIG. 2 schematically illustrates additional detail of a compressor.

FIG. 3 is a cross-sectional view of a rotor and a rotor sleeve.

FIG. 4 is a view similar to FIG. 3 and illustrates a path of magnetic flux.

FIG. 5 is a perspective view of an example arrangement of the sleeve including a plurality of axially stacked rings.

FIG. 6 is a perspective view of another example arrangement of the sleeve.

FIG. 7 is a view similar to FIG. 3 and illustrates an outer casing of the sleeve.

FIG. 8 is a cross-sectional view of a portion of an example electric machine, and in particular illustrates an example sleeve arrangement.

FIG. 9 is a cross-sectional view of a portion of another example electric machine, and in particular illustrates yet another example sleeve arrangement.

FIG. 10 is a cross-sectional view taken along line 10-10 from FIG. 9.

### DETAILED DESCRIPTION

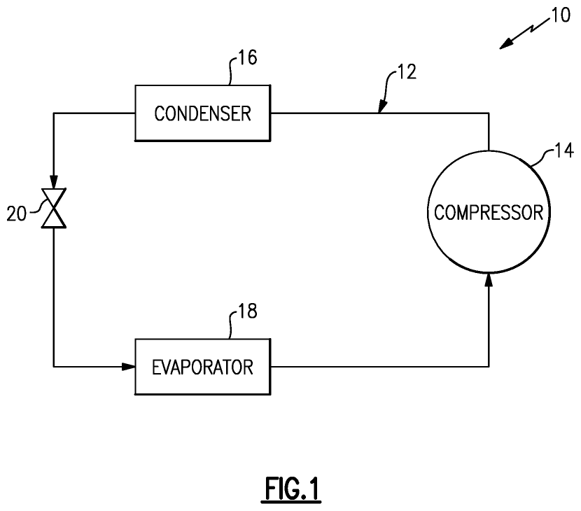

FIG. 1 illustrates a refrigerant system 10. The refrigerant system 10 includes a main refrigerant loop, or circuit, 12 in communication with a compressor 14, a condenser 16, an evaporator 18, and an expansion device 20. This refrigerant system 10 may be used in a chiller, for example. In that example, a cooling tower may be in fluid communication with the condenser 16. While a particular example of the refrigerant system 10 is shown, this application extends to other refrigerant system configurations, including configurations that do not include a chiller. For instance, the main refrigerant loop 12 can include an economizer downstream of the condenser 16 and upstream of the expansion device 20. This disclosure also applies outside the context of refrigeration, and could apply to turbine generators, air compressors, organic Rankine cycles, etc. Further, while a compressor is mentioned, this disclosure applies to turbomachines generally. This disclosure also applies to electric machines generally, including motors and generators, whether or not those electric machines are used in a compressor or a turbomachine. For instance, the electric machine of this disclosure may be used in a generator for a power plant, such as a concentrated solar power plant, a wind power plant, a nuclear power plant, etc.

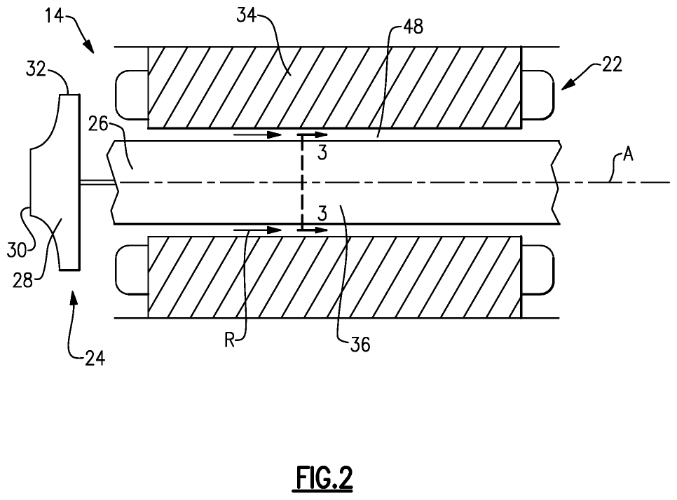

FIG. 2 illustrates an example refrigerant compressor 14 (“compressor 14”) according to this disclosure. The compressor 14 includes an electric motor 22 (“motor 22”) which drives a compression stage 24. The motor 22 is connected to the compression stage 24 via a shaft 26, which is illustrated partially schematically, and is rotatable about a central axis A. The shaft 26 may be supported within a housing of the compressor 14 by one or more magnetic bearings. While magnetic bearings are mentioned, this disclosure extends to applications that do not include magnetic bearings. Other bearings, such as foil bearings, gas bearings, high-speed ball bearings, oil-pressured bearings, etc., could be used. The compression stage 24 may include one or more impellers. In FIG. 2, the compression stage 24 includes an impeller 28 configured to receive an axial flow of fluid at an inlet 30 and expel the pressurized flow radially at an outlet 32. Again, while a motor 22 is illustrated in the drawings, this disclosure extends to electric machines operable as a motor and/or a generator.

The motor 22 includes a stator 34 arranged radially outside of a rotor 36. The rotor 36, in this example, is made of magnetic material and is rotatable in response a magnetic field of the stator 34. In particular, the rotor 36 is made of a permanent magnet. The rotor 36 is configured to rotate with the shaft 26 and the compression stage 24.

In one example of this disclosure, the rotor 36 is provided by magnetic material which is attached to the remainder of the shaft 26, which may be non-magnetic. In this example, the motor 22 includes a sleeve 38 (FIG. 3) configured to connect and attach the rotor 36 to the remainder of the shaft 26.

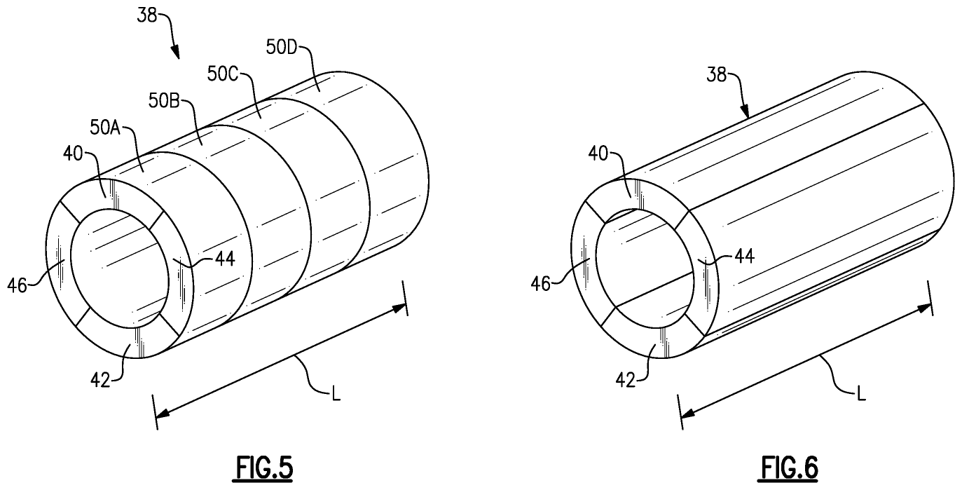

In FIG. 3, the sleeve 38 is radially outward of and radially surrounds the rotor 36 about the entire circumference of the rotor 36. The sleeve 38 may be considered part of the rotor 36 and/or a part of the shaft 26, and may be referred to as a rotor sleeve. In this regard, the rotor 36 and sleeve 38 may together be considered a rotor or rotor assembly. The sleeve 38 extends axially along a length L (FIGS. 5 and 6) that is longer than a length of the stator 34, in one example. In that example, the sleeve 38 extends from a point axially forward (to the left relative to FIG. 2) of the stator 34 to a point axially behind (to the right) of the stator 34. Further, the length L of the sleeve 38 is longer than the length of the rotor 36 such that the sleeve 38 projects axially beyond the axial ends of the rotor 36 and can connect to the shaft 26.

In one example, the shaft 26 includes a radial recess, and the sleeve 38 rests in the recess and is radially flush with the remainder of the shaft 26. FIG. 8, for example, illustrates a configuration in which the shaft 26 includes a radial recess 27 exhibiting a reduced diameter relative to the remainder of the shaft 26 and the rotor 36 also exhibits that same reduced diameter. The sleeve 38 rests in the radial recess 27 and against the outer diameter of the rotor 36 and is flush with the remainder of the shaft 26. Further, in FIG. 8, the rotor 36 is provided by a single-piece permanent magnet.

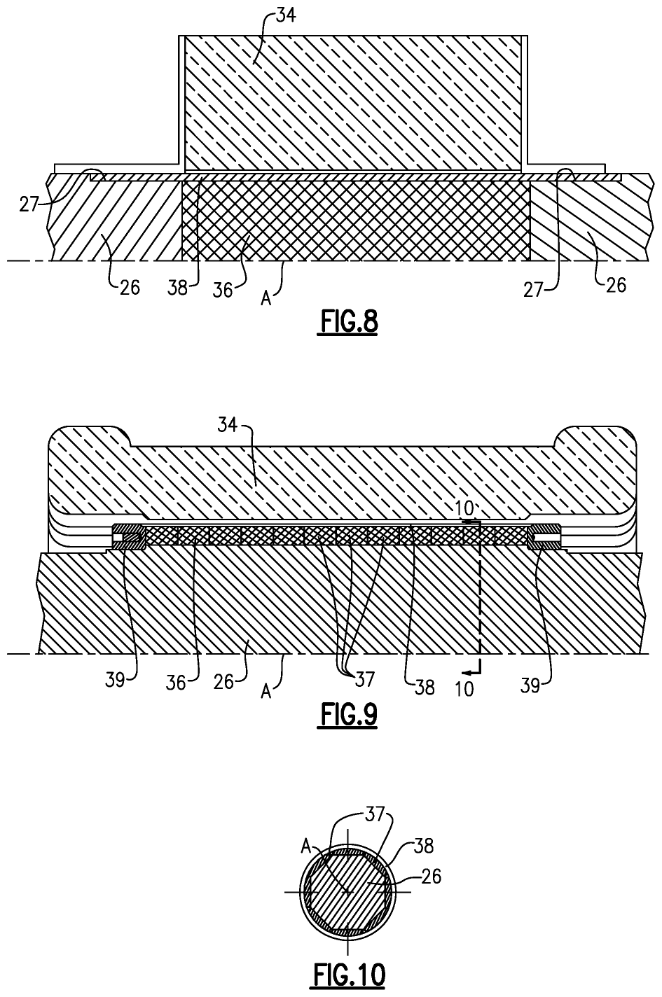

In another example, the sleeve 38 may cover permanent magnets which provide the rotor 36 and are attached to an outer surface of the shaft 26. In that case, the sleeve 38 may project radially outward of the remainder of the shaft 26. FIGS. 9 and 10 illustrate an example configuration in which the rotor 36 is provided by a plurality of permanent magnets 37 which are connected to the shaft 26 and are arranged radially outward of the shaft 26. The magnets 37 are axially abutted to one another. The sleeve 38 is radially outward of the magnets 37. The sleeve 38 is connected at its axial ends to fixed rings 39, which are configured to rotate with the shaft 26. The fixed rings 39 also abut ends of the forward-most and rearward-most magnets 37. The magnets 37, in this example, exhibit an inner diameter having a substantially flat contour configured to match a contour of the shaft 26, which in this example is octagonal in cross-section (FIG. 10). The magnets 37 also exhibit a curved outer corresponding to the circular cross-section of the sleeve 38. In any of the aforementioned examples, the sleeve 38 is configured to rotate with the shaft 26 and the rotor 36.

In this example, the sleeve 38 includes at least two arc segments, one of which is provided by a magnetic material and the other of which is provided by a non-magnetic material. The sleeve 38 may include additional arc segments. In a further example, the sleeve 38 includes at least two pairs of arc segments, one pair being magnetic and the other pair being non-magnetic. In FIG. 3, the sleeve 38 includes first and second magnetic arc segments 40, 42 and first and second non-magnetic arc segments 44, 46. The first and second arc segments 40, 42 are provided by soft magnetic material, such as a ferritic metal, and the first and second non-magnetic arc segments 44, 46 are provided by non-magnetic material, such as a austenitic steel. The first and second magnetic arc segments 40, 40 may be provided by metallic soft magnetic steel with low reluctance to thereby allow magnetic flux to flow through them with relative ease, and thus may be referred to as soft magnetic arc segments. The magnetic and non-magnetic arc segments are alternately arranged about the circumference of the sleeve 38. Further, in one example, the segments are not mechanically independent and the sleeve 38 do not include any circumferential seams. Rather, the segments are sections of the sleeve 38 that are treated in a different manner to exhibit different magnetic properties. A radially inner surface of each of the segments is in direct contact with an outer portion of the rotor 36, which here is provided by a piece of magnetic material. The radially outer surface of each of the segments is radially flush with a remainder of the shaft 26 or, alternatively, projects outward of the remainder of the shaft 26.

The first and second magnetic arc segments 40, 42 are on circumferentially opposite sides of the axis A, in this example, and are spaced-apart from one another by non-magnetic arch segments 44, 46. The segments, in this example, each occupy about 90° of the circumference of the sleeve 38. Alternately arranging the magnetic and non-magnetic segments prevents a situation where the sleeve 38 would act as a magnetic insulator.

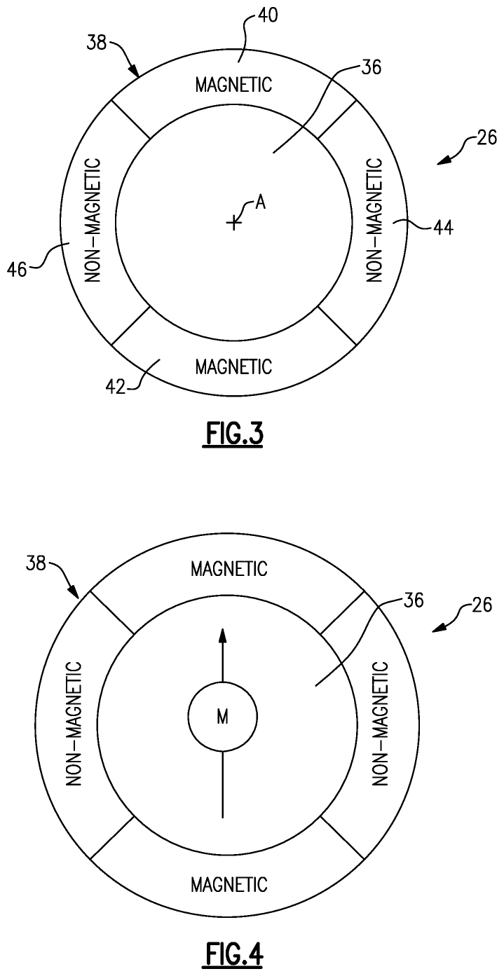

The sleeve 38 is arranged such it exhibits low reluctance and such that a path of magnetic flux M, shown in FIG. 4, across the rotor 36 and shaft 26 is optimized. As such, there is an increased flux density in the air gap 48 (FIG. 2) radially between the stator 34 and the rotor 36, and in particular the sleeve 38. This also provides an increase in electromagnetic torque and electromagnetic power density of the machine for the same rotor volume. Further, less number of turns per coil are needed to obtain equivalent back electromotive force (BEMF), and equivalent electromagnetic torque and power are obtained.

In rotary machines, such as refrigerant compressors, coolant, which here is refrigerant R, is sometimes used to cool the motor 14. The refrigerant R may flow through the air gap 48 to cool the stator 34 and rotor 36. Using the sleeve 38, the diameter and length of the rotor 36 may be reduced without reducing the power of the motor 14 and, in some cases, the power of the motor 14 can even increase. Reducing the diameter and length of the rotor 36 reduces windage losses associated with drag of the refrigerant R within the air gap 48. Thus, the motor 22 can be cooled more efficiently and effectively.

With reference to FIG. 5, the sleeve 38 could include a plurality of axially-abutted rings 50_{A}-50_{D} along the length L of the sleeve 38. Each of the rings 50_{A}-50_{D} extends circumferentially about the axis A. While four rings 50_{A}-50_{D} are shown, there could be additional rings. In an example, the rings 50_{A}-50_{D} each include the same arrangement of magnetic arc segments spaced-apart by non-magnetic arc segments. The rings 50_{A}-50_{D} are arranged such that like arc segments are radially and circumferentially aligned with one another and directly abut one another. In an example, each ring 50_{A}-50_{D} has a length of about 0.2 mm and the overall length L of the sleeve 38 is about 100 mm. In this example, there are about 500 rings in the sleeve 38. This disclosure extends to sleeves with other numbers of rings. The rings 50_{A}-50_{D} may be laminated to one another or connected in another manner. Further, each individual ring may be laminated and thus be electrically insulated. Providing the sleeve 38 with a plurality of axially-stacked, laminated rings reduces eddy current loss by breaking eddy currents along the length of the sleeve 38, as eddy currents do not travel between the rings. In FIG. 5, each ring is a seamless hoop, continuously extending about the axis A, and the arc segments are treated to exhibit the magnetic properties discussed above.

Alternatively, as in FIG. 6, each arch segment may extend the entire length L of the sleeve 38. In the example of FIG. 6, each arc segment could be provided by a different piece of material and mechanically attached (e.g., welded) to the other arc segments. In that example, arc segments 40, 42 may be provided by a soft magnetic steel material, and arc segments 44, 46 may be provided by a non-magnetic steel material.

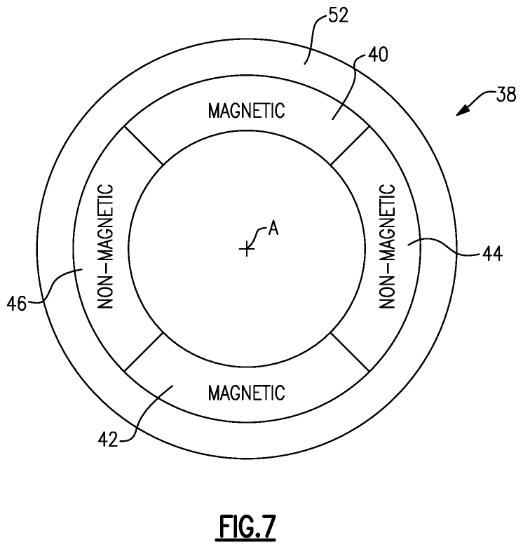

In FIG. 7, the sleeve 38 includes an outer casing 52 radially surrounding the arc segments. The outer casing 52 may be provided by a non-magnetic material, such as carbon fibers or an alloy or superalloy, such as Inconel. The outer casing 52 may increase the bonding strength of the overall sleeve 38. The outer casing 52 extends along the entire length of the sleeve 38 in an example.

It should be understood that terms such as “axial,” “radial,” and “circumferential” are used above with reference to the normal operational attitude of an electric machine. Further, these terms have been used herein for purposes of explanation, and should not be considered otherwise limiting. Terms such “generally,” “about,” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An electric machine, comprising:
a rotor, the rotor including a sleeve radially outside a permanent magnet, the sleeve including at least one magnetic arc segment and at least one non-magnetic arc segment.

2. The electric machine as recited in claim 1, wherein the sleeve is configured to rotate with the permanent magnet.

3. The electric machine as recited in claim 1, further comprising a stator radially surrounding the sleeve, wherein the stator is arranged such that an air gap is present radially between the stator and the sleeve.

4. The electric machine as recited in claim 1, wherein the sleeve includes at least one pair of magnetic arc segments and at least one pair of non-magnetic arc segments alternately arranged about a circumference of the sleeve.

5. The electric machine as recited in claim 4, wherein the magnetic and non-magnetic arc segments are not mechanically independent such that the sleeve does not include any circumferential seams.

6. The electric machine as recited in claim 1, wherein the sleeve includes a plurality of rings axially abutted to one another.

7. The electric machine as recited in claim 6, wherein each of the rings is arranged such that the magnetic and non-magnetic arc segments are aligned both radially and circumferentially with the magnetic and non-magnetic arc segments, respectively, of an adjacent ring.

8. The electric machine as recited in claim 1, wherein the magnetic and non-magnetic arc segments extend along an entire length of the sleeve.

9. The electric machine as recited in claim 1, wherein the sleeve includes a non-magnetic outer casing.

10. The electric machine as recited in claim 1, wherein the permanent magnet is connected to a shaft via the sleeve.

11. The electric machine as recited in claim 10, wherein the sleeve is radially flush with the shaft.

12. The electric machine as recited in claim 10, wherein the sleeve projects radially outward of the shaft.

13. The electric machine as recited in claim 10, wherein the electric machine is configured for use in a refrigerant compressor used in a heating, ventilation, and air conditioning (HVAC) chiller system.

14. The electric machine as recited in claim 1, wherein the electric machine is one of a motor and a generator.

15. A refrigerant compressor for a heating, ventilation, and air conditioning (HVAC) chiller system, comprising:
an impeller;
a shaft connected to the impeller;
an electric motor including a rotor, the rotor including a sleeve radially outside of a permanent magnet, the sleeve connecting the permanent magnet to the shaft, wherein the sleeve includes at least one magnetic arc segment and at least one non-magnetic arc segment.

16. The refrigerant compressor as recited in claim 15, wherein the sleeve includes at least one pair of magnetic arc segments and at least one pair of non-magnetic arc segments alternately arranged about a circumference of the sleeve.

17. The refrigerant compressor as recited in claim 16, wherein the magnetic and non-magnetic arc segments are not mechanically independent such that the sleeve does not include any circumferential seams.

18. The refrigerant compressor as recited in claim 16, wherein:
the sleeve includes a plurality of rings axially abutted to one another, and
each of the rings is arranged such that the magnetic and non-magnetic arc segments are aligned both radially and circumferentially with the magnetic and non-magnetic arc segments, respectively, of an adjacent ring.
